(19) United States
(12) Patent Application Publication
(10) Pub. No.: US 2024/0039324 A1
(43) Pub. Date: Feb. 1, 2024

(54) ENERGY ALLOCATION AND MANAGEMENT SYSTEM

(71) Applicant: Block Energy LLC, Tampa, FL (US)

(72) Inventor: Luis Eduardo Zubieta, Oakville (CA)

(73) Assignee: Block Energy LLC, Tampa, FL (US)

(21) Appl. No.: 18/483,863

(22) Filed: Oct. 10, 2023

Related U.S. Application Data
(63) Continuation of application No. PCT/IB2022/000209, filed on Nov. 4, 2022.
(60) Provisional application No. 63/201,061, filed on Apr. 9, 2021.

(51) Int. Cl. H02J 13/00; H02J 3/00; H02J 3/32

(52) U.S. Cl. CPC H02J 13/00007; H02J 3/003; H02J 3/004; H02J 3/32; H02J 13/00002; H02J 3/007; H02J 13/00032; H02J 2300/28; H02J 2300/26; H02J 2203/10; H02J 3/381

(57) ABSTRACT

Controllers and control methods for a power system are disclosed. The controllers can be configured to perform operations for correcting a state of a first node of the power system. The operations can include obtaining rules for correcting the state of the first node, each rule specifying a corrective action for the first node. The operations can further include obtaining instructions for the first node, the instructions at least partially specifying a configuration of the first node. The operations can further include generating a forecast for the state of the first node based on the instructions and monitoring the state of the first node. Based on the forecast state and the monitored state of the first node, the controller can select one of the rules and apply the corrective action specified by the selected rule to correct the state of the first node.

### CROSS-REFERENCE TO RELATED APPLICATIONS

This application is a continuation of International Patent Application No. PCT/IB2022/000209, titled “Energy Allocation and Management System”, filed on Apr. 11, 2022, which claims priority to and the benefit of U.S. Provisional Patent Application No. 63/201,061, titled “Management Systems and Methods”, filed on Apr. 9, 2021, and the specification and claims thereof are incorporated herein by reference.

### BACKGROUND OF THE INVENTION

Traditional electrical power systems can operate using large, centralized power generation resources and unidirectional power flow to the loads. The transmission and distribution networks appear as infinite energy resources to the loads. With the proliferation of distributed generation resources, the power flow has become bidirectional. Furthermore, those renewable resources are intermittent in nature and require the use of distributed energy storage resources to keep the system stable and controllable.

Despite the advantages of centralized control for optimization and monitoring, decentralized control of distributed resources is a preferred control principle as it gives scalability and flexibility to the installations without the need for expensive and time-consuming reconfiguration. Common operation principles and implementation techniques are usable in diverse decentralized systems. On the other hand, each centralized system needs to be specific and custom designed. Microgrids where multiple resources and loads are operating simultaneously can introduce additional challenges to the management of energy storage resources. These challenges can be accentuated when the energy storage is used to power balance the system.

Energy storage can be used in many different applications. The strategy used to manage the energy storage depends on the specific application. For example, in backup applications, the storage can be maintained fully charged until an event necessitating discharge occurs. In electric vehicles (EVs), the battery can be charged while the loads are idle and then managed to handle acceleration and braking while estimating the remaining driving range. In solar plus storage applications, the storage can be managed to ensure maximum solar energy storage during the sun hours to level or shift the production as needed.

### BRIEF SUMMARY OF THE INVENTION

The disclosed systems and methods concern the control of energy dispatch and energy allocation.

The envisioned embodiments include a controller for managing power transfer in a distributed power transmission system. The controller can include at least one processor and at least one memory storing instructions. When executed by the at least one processor, the instructions can cause the controller to perform operations. The operations can include receiving a forecast trajectory for a power node; determining a measured trajectory for the power node; determining an error signal using the forecast trajectory and the measured trajectory; and providing instructions to reduce the error signal. The instructions can be provided to at least one smart interface controller to transfer energy between the power node and at least one power system connected to the power node. The instructions can cause energy to be transferred between the power node and an energy storage device connected to the power node.

The envisioned embodiments include a controller for managing energy allocation in a distributed power transmission system. The controller can include at least one processor; and at least one memory storing instructions. When executed by the at least one processor, the instructions can cause the controller to perform operations. The operations can include receiving tasks and corresponding priorities for a power node; and for an interval: iteratively in priority order for each task: determine an energy requirement amount for the task; and when the energy requirement amount is less than an available energy amount: allocate the energy requirement amount to the task; and update the available energy amount based on a total available energy amount and the energy requirement amount. The operations can include providing instructions to a smart interface controller to transfer power between the power node and at least one power system connected to the power node, based on a first energy requirement amount allocated to a first task of ensuring an energy supply to loads connected to the power node. The instructions can cause energy to be transferred between the power node and an energy storage device connected to the power node, based on a second energy requirement amount allocated to a second task of maintaining the energy storage device on a stored energy trajectory.

The disclosed embodiments include a controller for a power system. The controller can include at least one processor and at least one memory storing instructions that, when executed by the at least one processor, cause the controller to perform operations for correcting a state of a first node of the power system. The operations can include obtaining rules for correcting the state of the first node, each rule specifying a corrective action for the first node. The operations can further include obtaining instructions for the first node, the instructions at least partially specifying a configuration of the first node. The operations can further include generating a forecast for the state of the first node based on the instructions. The operations can further include monitoring the state of the first node. Based on the forecast state and the monitored state of the first node, the controller can select one of the rules and apply the corrective action specified by the selected rule to correct the state of the first node.

The disclosed embodiments include a method for correcting a state of a node of a power system. The methods can include obtaining rules for correcting the state of the first node, each rule specifying a corrective action for the first node; obtaining instructions for the first node, the instructions at least partially specifying a configuration of the first node; generating a forecast for the state of the first node based on the instructions; and monitoring the state of the first node. Based on the forecast state and the monitored state of the first node, once of the rules can be selected and the corrective action specified by the selected rule applied to correct the state of the first node.

The disclosed embodiments include a controller for a node in a power system. The controller can include at least one processor and at least one memory storing instructions that, when executed by the at least one processor, cause a controller of the node to perform operations. The operations can include obtaining functions and corresponding priorities. The operations can include allocating, in an energy storage device of the node, time-dependent energy storage capacities for the functions based on the priorities. Such allocating can include selecting a function based on the corresponding priorities; selecting a time interval; determining an energy requirement amount for the selected function in the selected time interval; and determining that the energy requirement amount is less than an available energy capacity of the energy storage device and, in response to the determination, allocating an amount of available energy capacity in the energy storage device to performance of the function during the interval. The operations can include determining, in response to a request to perform a first function, an amount of power transferable from the energy storage device based on the time-dependent energy storage capacity for the first function. The operations can include providing instructions to configure the node to transfer the determined amount of power from the energy storage device.

The disclosed embodiments include a method performed by a controller of a node for allocating power in an energy storage device of a node. The method can include obtaining functions and corresponding priorities. The method can include allocating, in the energy storage device, time-dependent energy storage capacities for the functions based on the priorities. Such allocation can include selecting a function based on the corresponding priorities; selecting a time interval; determining an energy requirement amount for the selected function in the selected time interval; and determining that the energy requirement amount is less than an available energy capacity of the energy storage device and, in response to the determination, allocating an amount of available energy capacity in the energy storage device to performance of the function during the interval. The method can include determining, in response to a request to perform a first function, an amount of power transferable from the energy storage device based on the time-dependent energy storage capacity for the first function. The method can include providing instructions to configure the node to transfer the determined amount of power from the energy storage device.

It is to be understood that both the foregoing general description and the following detailed description are exemplary and explanatory only and are not restrictive of the disclosed embodiments, as claimed.

### BRIEF DESCRIPTION OF THE SEVERAL VIEWS OF THE DRAWINGS

The drawings are not necessarily to scale or exhaustive. Instead, emphasis is generally placed upon illustrating the principles of the embodiments described herein. The accompanying drawings, which are incorporated in and constitute a part of this specification, illustrate several embodiments consistent with the disclosure and, together with the description, serve to explain the principles of the disclosure. In the drawings:

FIG. 1 depicts a method for updating system operation using an energy dispatch plan, in accordance with disclosed embodiments.

FIG. 2 depicts an exemplary node including energy generation and storage resources, in accordance with disclosed embodiments.

FIG. 3 depicts a hypothetical example of real time adjustment, in accordance with disclosed embodiments.

FIG. 4 depicts a hypothetical example of real time adjustment in which a load continuously differs from an energy dispatch plan, in accordance with disclosed embodiments.

FIG. 5 depicts an exemplary method for allocating stored energy, consistent with disclosed embodiments.

FIG. 6 depicts an exemplary energy allocation between functions over time, in accordance with disclosed embodiments.

FIG. 7 depicts an exemplary energy allocation between functions overtime, given a request from the grid to provide 3 hours of support starting at a first time interval, in accordance with disclosed embodiments.

FIG. 8 depicts an exemplary energy allocation between functions overtime, given a request from the grid to provide 3 hours of support starting at a second time interval, in accordance with disclosed embodiments.

### DETAILED DESCRIPTION OF THE INVENTION

Reference will now be made in detail to exemplary embodiments, discussed with regards to the accompanying drawings. In some instances, the same reference numbers will be used throughout the drawings and the following description to refer to the same or like parts. Unless otherwise defined, technical and/or scientific terms have the meaning commonly understood by one of ordinary skill in the art. The disclosed embodiments are described in sufficient detail to enable those skilled in the art to practice the disclosed embodiments. It is to be understood that other embodiments may be utilized and that changes may be made without departing from the scope of the disclosed embodiments. For example, unless otherwise indicated, method steps disclosed in the figures can be rearranged, combined, or divided without departing from the envisioned embodiments. Similarly, additional steps may be added, or steps may be removed without departing from the envisioned embodiments. Thus the materials, methods, and examples are illustrative only and are not intended to be necessarily limiting.

### Energy Dispatch Planning

Conventional methods for dispatching power systems that integrate multiple resources including renewable energy and energy storage systems can rely on generation and load forecast to make decisions regarding the appropriate operation of the resources. Deviations between the actual generation and load and the forecasted values can result in unsuitable operations or require frequent adjustments to planned operations. In decentralized systems, operation planning can be executed by a high-level control system and then communicated to the decentralized nodes, or can be executed in the distributed nodes based on system data communicated from central servers. Frequent recalculation of the operation plan pushes the control approach away from plug-and-play decentralized control.

Consistent with disclosed embodiments, nodes in a power system can compensate for deviations from a forecasted state, without requiring recalculation of an overall dispatch plan for the power system or communication between nodes in the power system. State variables for a node can be monitored, to identify deviations from planned values. The state variables can be selected such that deviations can be identified before the node has drifted too far from planned operations. For example, in some embodiments the nodes can include energy storage. This energy storage can be used to compensate for changes in renewable generation or load consumption. Monitored state variables can include operating conditions of the energy storage (e.g., battery power, state of charge, battery temperature, or the like).

The disclosed embodiments can be suitable for decentralized control of nodes in a power system and can be executed independently for each node of the power system. Consistent with disclosed embodiments, nodes in a power system can identify and react to deviations in monitored state variables independently of other nodes in the power system and without the need for fast and reliable communication.

Accordingly, the disclosed embodiments can enhance the decentralized operation of the power system. The disclosed embodiments can increase the reliability, scalability, and flexibility of the decentralized system, while supporting the satisfaction of overall power system performance requirements, despite uncertainty in forecasted states. Furthermore, the disclosed embodiments can enable efficient use of distributed energy resources (e.g., generation or storage) and thereby reduce project equipment and design requirements.

### Dispatch Correction

Consistent with disclosed embodiments, a power-system-level dispatch plan can be generated based on an overall forecast of power generation and use for the power system. Instructions for implementing this plan can be distributed to nodes in the power system. The nodes in the power system can execute these instructions, thereby implementing the dispatch plan. Real-time communication capabilities between nodes in the power system are not required as the dispatch plan is generated in advance. The instructions to implement the plan can be distributed to nodes using low-bandwidth or low-cost networks. For example, power line communication methods can be used to transmit such instructions. As an additional example, instructions can be distributed when bandwidth is readily available (e.g., at night) for subsequent use (e.g., the next day).

The nodes in the power system can configure internal resources (e.g., generation sources, energy storage source, power connections between the node and other nodes) according to the instructions to implement the dispatch plan. Consistent with disclosed embodiments, a node can generate a forecast of the state of the node over an interval (e.g., a trajectory of the state) based on expected operating conditions during that interval. For example, the dispatch plan can specify the power a local node can expect to receive from a community node over a 24-hour interval. The local node can then forecast a trajectory of the state based on the estimated power received and other factors (e.g., historical power generation from distributed power generation sources attached to the node, historical power usage from loads attached to the node, or the like). As described herein, the state can include a status or configuration of the node. For example, when the node includes an energy storage device, the state of the node can include status information of the energy storage device (e.g., state of charge, temperature, average or instantaneous power transfer, or the like). Likewise, when the node includes power connections to another node, a main power source (e.g., a power grid), or a secondary power source (e.g., an intermittent power source such as a solar array, wind turbine, or other renewable energy source), the state of the node can include the configuration of these power connections (e.g., the specified and/or actual amount and direction of average or instantaneous power transfer). Similarly, when the node is associated with loads, the state can include the average or instantaneous power requirements of each load (or all loads). In some embodiments, when the node can be configured to disconnect power sources or loads from the node, the state can include whether the power sources or loads are connected or disconnected.

Consistent with disclosed embodiments, during the interval, the node can compare the actual state of the node to the forecasted state of the node. The actual state of the node can be obtained from measurement data. This data can be obtained in real time from sensors associated with the node. If the actual state of the node begins to differ from the forecasted state of the node, the node can immediately detect the deviation. The node can then automatically execute corrections to the configuration of the internal resources of the node to adjust the state of the node back to the forecasted state. Accordingly, corrections to the configuration of the node can be implemented before any major deviation in energy availability, energy utilization, or system performance is observed. Furthermore, the corrections can be locally executed by the decentralized node without the need to communicate with any higher-level control node or recalculate the system-level dispatch plan.

Consistent with disclosed embodiments, the node can be configured with rules for automatically reconfiguring the internal resources of the node to return the state of the node to the forecasted state. Such rules can specify how one or more of the internal resources should be reconfigured to correct deviations from the forecasted state. For example, the renewable generation and load demand can be forecasted based on environmental data and past performance. Using the forecasted data, a controller executes an optimization algorithm that results in power dispatch actions. However, the forecast data is always susceptible to errors due to climatic and operating conditions that cannot be anticipated.

In some embodiments, the optimization produces, amongst other data, a time plot for the expected energy storage power and the expected energy storage state of charge. The storage power and state of charge during operation are measured and compared with the optimization data. If the storage power is above the expected value by a predetermined amplitude and duration, the system will react by changing the power dispatched by some of the components so that the power is recovered to a value closer to the optimization data. Accordingly, the node can monitor the state of the node and apply rules as necessary to correct deviations from the forecast state.

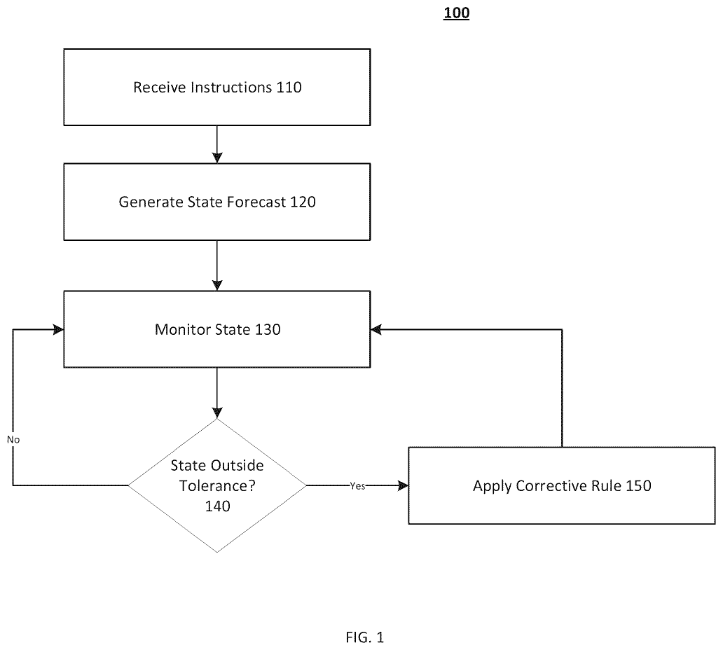

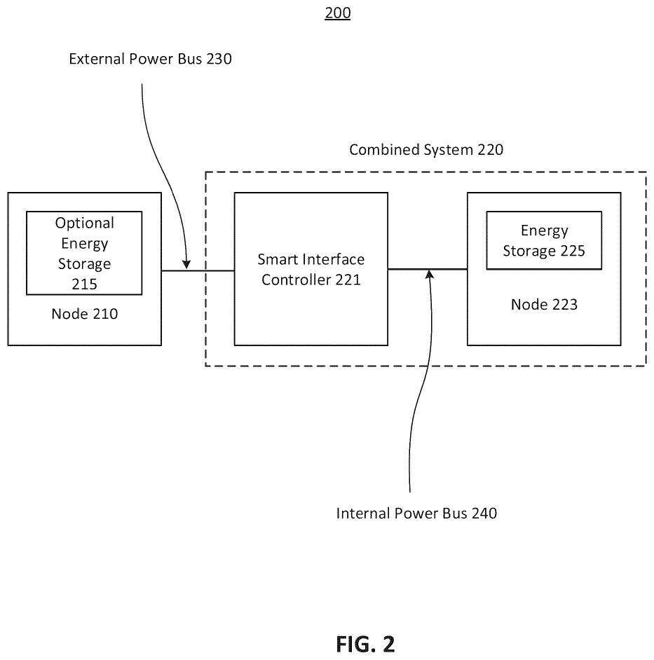

FIG. 1 depicts a method 100 for updating system operation. Consistent with disclosed embodiments, method 100 can be implemented by a node comprising a controller, an energy storage source, one or more loads, and one or more power connections. Such power connections can connect the node with another node or with a power source. Such power sources can be or include intermittent power sources (e.g., peaking plants; grid-level energy storage; or solar power sources, wind power sources, tidal power sources, or other renewable power sources). For example, a local node can have two power connections. A first power connection can connect the local node to a community node that acts as a main energy source for the local node. A second power connection can connect the local power to a renewable energy source that provides intermittent power to the local node. An example of such an arrangement is described below with respect to FIG. 2.

In step 110 of method 100, the local node can receive instructions. The instructions can be received from another node (e.g., a community node), a power source, or a high-level controller (e.g., a controller associated with the overall power system of which the local node may be a component), or a similar component of the power system.

The instructions can enable the node to implement an intended role within a dispatch plan associated with the power system of which the node is a component. In general, the dispatch plan may be designed to reduce costs associated with the overall power system (e.g., generation costs, distribution costs, maintenance costs, or the like), shift power generation from one source to another (e.g., from fossil fuel generation to renewable generation), improve system reliability (e.g., fill local energy storage in advance of a heat wave that is anticipated to strain power generation and distribution capabilities), or otherwise improve the functioning of the power system.

In some embodiments, the instructions can at least partially specify a configuration of the node. Such a configuration can include power exchanges, load maintenance or shedding, energy storage levels, or other aspects of the node. For example, the instructions can specify power exchanges over the power connection(s) of the node. These power exchanges can be specified as a function of time. For example, a node can receive instructions to draw, over a connection with a community node, 4 kW between 12:00 AM and 6:00 AM, 1 kW between 6:00 AM and 8:00 PM, and 4 kW between 8:00 PM and 11:59 PM. Such power exchanges can be specified in terms of current (e.g., amperes), potential (e.g., voltage), power (e.g., watts), energy (e.g., joules or kilowatt-hours), or another suitable metric.

The disclosed embodiments are not limited to any particular transmission modality or format for the instructions. In some embodiments, the instructions can be transmitted over a power connection (e.g., using an AC or DC power-line communication modality). In various embodiments, the instructions can be transmitted through a different channel than the power received by the node. For example, the instructions can be received through a wired (e.g., coaxial cable, phone line, network cable, or similar suitable connections) or wireless (e.g., cellular, WIFI, BLUETOOTH, ZIGBEE, infrared, radio, or similar suitable connections) channel. In some embodiments, the instructions can be implemented using a data-interchange format, such as XML, JSON, or the like.

In step 120, the node can be configured to generate a forecast of a state of the node. In some embodiments, as described herein, the state of the node can include variables describing a status of the node or components thereof (e.g., an amount of stored energy of the node) and/or variables describing the node configuration (e.g., battery temperature or discharge rate; internal bus voltage or current; average or instantaneous power usage or net power usage; current or power drawn exchange with other nodes, or other suitable information). The forecast can be a trajectory of the node in a state space.

The node can generate the forecast of the state of the node based on the received instructions and other information. The other information can concern factors that potentially affect the configuration of the node. For example, the other information can include historical load information, environmental information (e.g., temperature, precipitation, cloudiness, wind speed and direction, or other factors that might affect energy demand or energy production). The other information can be historical, current, or prospective. For example, the other information can include historical records of energy usage for a day of the year. As an additional example, the other information can include weather forecasts.

Consistent with disclosed embodiments, the other information can be obtained by the node. The node can receive or retrieve the other information from an external source (e.g., weather information could be obtained from a website using an API exposed by that website, or a high-level controller associated with the power system could provide the weather information to the node). The node can generate the other information (e.g., by accumulating measurements of power consumption over time). The node can obtain the information using the same channel as the instructions received in step 110, or another such channel.

To continue a previous example, a local node can receive instructions to configure a power connection between the local node and a community node to request 4 kW between 12:00 AM and 6:00 AM, 1 kW between 6:00 AM and 8:00 PM, and 4 kW between 8:00 PM and 11:59 PM. Thus the node can obtain 54 kilowatt hours of energy over the course of the day from the community node. Based on historical energy usage, the node can forecast a load of 0.5 kW between 12:00 AM and 9:00 AM, a load of 7 kW between 9:00 AM and 5:00 PM and a load of 0.5 kW between 5:00 PM and 11:59 PM. Thus the node can expect usage of 64 kilowatt hours over the course of the day. To accommodate the expected shortfall of 10 kilowatt hours, the node can configure itself to obtain energy from another source (e.g., a renewable energy source) or to deplete energy storage by an energy storage device of the node. The node can configure obtaining energy from the other source or depleting the energy storage of the node according to performance criteria of the node. Assuming, in this example, that the state of the node includes the power received (or sent) to the community node, the power received from the other power source, the load, and the state of charge, the node can generate a forecast of these variables over the next 24 hours. This forecast can then be used to determine whether corrections must be applied to return the node to its intended operation conditions.

In step 130 of method 100, the node can be configured to monitor the state of the node. This monitoring can be performed using sensors that provide data accessible to the node. For example, a controller of the node can receive sensor data describing the status of an energy storage device of the node (e.g., a state of charge of a battery, or temperature of the battery), current drawn by loads attached to the node, current supplied by the community node, or the like. In some embodiments, the node can be configured to determine an actual trajectory of the state of the node in a state space.

In step 140 of method 100, the node can determine whether the state of the node is outside a tolerance range. Consistent with disclosed embodiments, method 100 can transition from step 130 to step 140 repeatedly, periodically, or according to some schedule.

This determination can depend on a single variable in the state (e.g., a state of change of a battery of the node), a combination of variables in the state (e.g., a battery temperature and power drawn by loads attached to the node), or a comparison of the trajectories of the forecast and actual states of the node in the state space. The determination can include applying rules to the state of the node. In such implementations, satisfaction of a rule (or failure to satisfy a rule) can indicate that the state of the node is out of tolerance. In some embodiments, the rules can describe a tolerance range for the variables (or combination of variables). A tolerance range can be expressed in absolute terms (e.g., +/−0.5 amps) or in relative terms (e.g., +/−5%). Tolerance ranges can be a function of time and date. For example, when a battery is recharged every night, a tolerance on the state of change of the battery can be higher in the evening than in the morning.

In some embodiments, determination of whether a state with within a tolerance can be formulated as applying a deadband function to a difference between the forecasted state variable and the measured value of that state variable. In some embodiments, a determination that a variable is out of tolerance can depend on the trajectory of the measured state variable, or the trajectory of the difference between the measured and forecasted state variable.

In some embodiments, variables in the state of the node can be checked according to a hierarchy or precedence. When the node is designed to provide current at a constant voltage to loads attached to the node through a common bus, the voltage of the common bus may be the first state variable checked. When the node is designed to maintain a storage battery between 20% and 80% charge, the state of charge of the battery may be the next variable checked. When an excessive rate of charging or discharging may overheat the battery, damaging it, the temperature of the battery may be the next variable checked.

If the state is not out of tolerance, method 100 can return to monitoring of the state of the node in step 130. Otherwise, method 100 can transition to step 150.

In step 150 of method 100, the node can apply a corrective rule, consistent with disclosed embodiments. Applying the corrective rule can include selecting the corrective rule to apply. In some embodiments, the node can be provisioned with corrective rules specific to each monitored state variable (or monitored combination of state variables). For example, a first rule may proscribe a corrective action for responding to a low state of charge, while a second rule may proscribe a corrective action for responding to greater than expected current demanded by loads. Thus the node can select the corrective rule to apply based on the state variable (or combination of state variables) that is out of tolerance.

In some embodiments, the node can be provided with multiple rules for a monitored state variable. For example, a first rule for responding to a low state of charge may be to begin drawing power from a secondary power generation source attached to the node (e.g., a peaking plant, solar array, windmill, or the like). A second rule for responding to a low state of charge may be to begin load-shedding procedures. In such embodiments, the node can select the rule to apply based on the magnitude of the departure of the state variable from the tolerance or whether a rule was previously applied.

For example, the node may be configured to initially apply a rule that imposes a minor corrective action (e.g., increasing power drawn from a community node, or the like). Method 100 can then return to monitoring the node in step 130, and then transition to determining whether the node is in tolerance. If the state variable remains out of tolerance, the node can apply another rule that imposes a more significant corrective action (e.g., load shedding, or the like). Alternatively, when faced with a major shortfall in the state of charge, the node can immediately apply a rule that causes it to begin load shedding.

In some instances, applying a corrective action can cause other state variables to depart from their forecasted values. For example, a local node may require additional power from a community node in response to a low state of charge. The additional power can appear as a deviation from the forecast amount of power obtained from the community node.

In some embodiments, application of a rule may cause the node to adjust tolerances of other variables. For example, a rule that implemented a corrective action by increasing power obtained from another node could cause the tolerance for obtaining such power to be increased.

In some embodiments, application of a rule may cause the node to re-forecast the state of the node. The updated forecast can incorporate the current state of the node and the consequences of the rules applied to the node.

FIG. 2 depicts a system 200 for power distribution, consistent with disclosed embodiments. System 200 can include multiple nodes (e.g., community node 210 and local node 223 of combined system 220) connected by power distribution buses (e.g., external bus 230 and internal bus 240) through smart interface controllers (e.g., smart interface controller 221) to enable decentralized control of power distribution, while minimizing the information communicated between nodes.

In some embodiments, the nodes of system 200 can be hierarchically arranged. Nodes with more generation or storage capabilities may provide power to nodes with lesser generation or storage capabilities. As a non-limiting example, a community including multiple residences can have a node associated with the community and a node associated with each of the residences. The node associated with the community can include a generation source (e.g., a coal-fired powerplant) and a utility-scale energy storage component (e.g., megawatt-hour capacity batteries). The nodes associated with the residences may or may not include generation components (e.g., solar panels) and may have smaller energy storage components (e.g., kilowatt-hour capacity batteries). In this example, the community node may typically provide power to each of the residential nodes. But the amount of power provided may vary between residential nodes, and under some circumstances the direction of power transfer may reverse, with a residential node providing power to the community node (e.g., a residential node with substantial solar generation capabilities can provide power to the community node on a sunny day).

Community node 210 can include an electrical power grid, a controller, and optionally energy storage component 215. In some embodiments, a single device can include, or provide the functionality of, optional energy storage component 215 and the controller. In various embodiments, separate devices can include, or provide the functionality of, optional energy storage component 215 and the controller. Community node 210 can include generation sources that provide power and loads that consume power. Community node 210 can be connected to combined system 220 through external power bus 230. Community node 210 can be configured to exchange power with combined system 220 using external power bus 230.

The electrical power grid can be configured to provide electrical current at a voltage amplitude (or within a voltage amplitude range). The electrical power grid can be an alternating current power grid or a direct current power grid. The disclosed embodiments are not limited to any particular topology or implementation of this power grid. In some embodiments, the electrical power grid in community node 210 can be or include external power bus 230.

In embodiments including energy storage component 215, this component can be configured to automatically provide or store power in order to maintain the electric power grid at a voltage amplitude or within a voltage amplitude range (e.g., voltage amplitude can be within −20% and +10% of a nominal value). In some embodiments, energy storage component 215 can be configured to address changes in power generation occurring on a timescale of less than a second, less than a minute, or less than an hour.

Optional energy storage component 215 can include at least one of an electrical (e.g. capacitive, or the like), electrochemical (e.g., battery or the like), mechanical (e.g., flywheel, compressed or liquid air, or the like), hydroelectric (e.g., pumped storage or the like), or similar energy storage system. In some embodiments, the storage component can be configured to sink or source direct current at a voltage. In some embodiments, energy storage component 215 can be directly connected to the power grid. For example, the storage device can be one or more batteries having terminals connected directly to the power grid. In such embodiments, a voltage of the electrical power grid can be automatically maintained at a setpoint determined by the energy storage component 215. For example, when the terminals of the one or more batteries are directly connected to the electrical power grid, the voltage of the electrical power grid can automatically depend on a state of charge of the battery, without requiring additional hardware or software. In various embodiments, the storage component can be indirectly connected to the power grid. For example, a converter (such as a DC/DC converter or power inverter) can be placed between the energy storage component and the power grid. The converter can be configured to sink or source power from the electrical power grid as necessary to maintain a voltage of the electrical power grid at a setpoint or within a range (e.g., a predetermined setpoint or range).

The controller (not shown) of community node 210 can be configured to manage community node 210 to maintain a state of community node 210 within a tolerance (e.g., as described herein with respect to FIG. 1). In some embodiments, the controller can be configured to monitor variations in power generation and demand on a timescale of a minute to an hour, or an hour to a day, or multiple days.

The controller can be configured to manage the community node 210 based on information concerning or affecting the past, present, or future state of community node 210, as described herein. In some embodiments, the controller can be configured to receive this information using one or more communications networks (e.g., a local area network, wide area network, mobile network, or the like). For example, the controller can be connected to other components of community node 210 over a local area network and to external devices over a mobile network or the internet.

The controller of community node 210 can be configured to manage community node 210 by modifying power generation, power usage, or power storage within community node 210. The controller can modify power generation by adding or removing power generation sources to or from the power grid. For example, the controller can provide instructions to configure renewable power generation sources such as wind turbines or solar panels to contribute power to the power grid. As an additional example, the controller can provide instructions to start or stop generators connected to the power grid, such as gas peaking plants or other power plants. The controller can be configured to manage local power use by providing instructions to adjust power consumption by devices connected to the electrical power grid of community node 210. For example, the controller can modify power usage by providing instructions to shed loads or reschedule the actions of devices connected to the electrical power grid of community node 210. For example, the controller can provide instructions to turn off or reschedule operation of an air conditioning unit or turn off external lights on a dwelling. In some embodiments, the power generation components or loads can automatically implement the instructions provided by the controller. In various embodiments, the instructions can be implemented at least partially manually.

The controller of community node 210 can manage community node 210 by requesting power transfers with other nodes. For example, community node 210 can be configured to provide a request to transfer power between community node 210 and another node. In some embodiments, the controller can provide instructions to a smart interface controller (e.g., smart interface controller 221). The smart interface controller can be connected to community node 210 by a power bus (e.g., external power bus 230) and connected to the other node by another power bus (e.g., internal power bus 240). Based on the instructions, smart interface controller 221 can transfer power between the community node and the other node.

External bus 230 can be configured to transfer power between the community node 210 and the combined system 220. External bus 230 can be configured to transfer direct current or alternating current and is not limited to a particular voltage amplitude (or frequency in embodiments using alternating current). In some embodiments, external power bus 230 can be, or be part of, the electrical power grid of community node 210.

In some embodiments, smart interface controllers can be included in nodes of system 200. For example, as depicted in FIG. 2, combined system 220 can include local node 223 and smart interface controller 221 (alternatively, a combined system could include community node 210 and smart controller 221, implemented as described herein). Consistent with disclosed embodiments, smart interface controller 221 can be configured to manage power transfers between community node 210 and local node 223.

Similar to community node 210, local node 223 can include a controller, an energy storage component (e.g., energy storage component 225) and an electrical power grid. In some embodiments, energy storage component 225 may be optional. In some embodiments, a single device can include, or provide the functionality of, at least two of the controller, energy storage component 225, and smart interface controller 221. In various embodiments, smart interface controller 221 can be separate from local node 223 (e.g., smart interface controller 221 can be implemented on a device separate from the device(s) implementing energy storage component 225 and the controller of local node 223). When a smart interface controller is included in a node, communications described herein as being sent to the smart interface controller may, in some embodiments, be sent to the node including the smart interface controller. This node may then act on the received communications, for example by forwarding them to the smart interface controller or communicating with the smart interface controller in response to the received communications. In some embodiments, smart interface controller 221 and the controller of node 223 can be the same controller. In such embodiments, instructions exchanged between the controller of node 223 and smart interface controller 221 can be processed internally by the combined controller.

The electrical power grid can be configured to provide electrical current at a voltage amplitude (or within a voltage amplitude range). The electrical power grid can be an alternating current power grid or a direct current power grid. The disclosed embodiments are not limited to any particular topology or implementation of this power grid. In some embodiments, the electrical power grid in local node 223 can be or include internal power bus 240.

Energy storage component 225 can be similar in construction and operation to energy storage component 215. Energy storage component 225 can be configured to automatically provide or store power in order to maintain the electric power grid at a voltage amplitude or within a voltage amplitude range (e.g., voltage amplitude can be within −20% and +10% of a nominal value). In some embodiments, energy storage component 225 can be configured to address changes in power generation occurring on a timescale of less than a second, less than a minute, or less than an hour. Energy storage component 225 can include at least one of an electrical, electrochemical, mechanical, hydroelectric, or similar energy storage system. In some embodiments, energy storage component 225 can be directly or indirectly connected to the electrical power grid.

The controller of local node 223 can be configured to operate similarly to the controller of community node 210. The controller of local node 223 can be configured to manage local node 223 to maintain a state of local node 223 within a tolerance, as described herein with regards to FIG. 1. In some embodiments, the controller can be configured to monitor the state of local node 223 on a timescale of a minute to an hour, or an hour to a day or multiple days.

Similar to the controller of community node 210, the controller of local node 223 can be configured to manage local node 223 based on information concerning or affecting the state of local node 223, as described herein. The controller can be configured to manage local power use by providing instructions to adjust power consumption by devices connected to the electrical power grid of local node 223. For example, the controller can modify power usage by providing instructions to automatically, or at least partially manually, shed loads, or reschedule the actions of devices connected to the electrical power grid of local node 223. In some embodiments, the controller can generate and/or consume instructions to transfer power between energy storage component 225 and other components of node 223. For example, the controller can determine that power should be stored in energy storage component 225 and then act upon that determination to cause energy storage component 225 to store power.

Internal bus 240 can be configured to transfer power between smart interface controller 221 and local node 223. Internal bus 240 can be configured to transfer direct current or alternating current and is not limited to a particular voltage amplitude (or frequency in embodiments using alternating current). In some embodiments, internal power bus 240 can be, or be part of, the electrical power grid of local node 223.

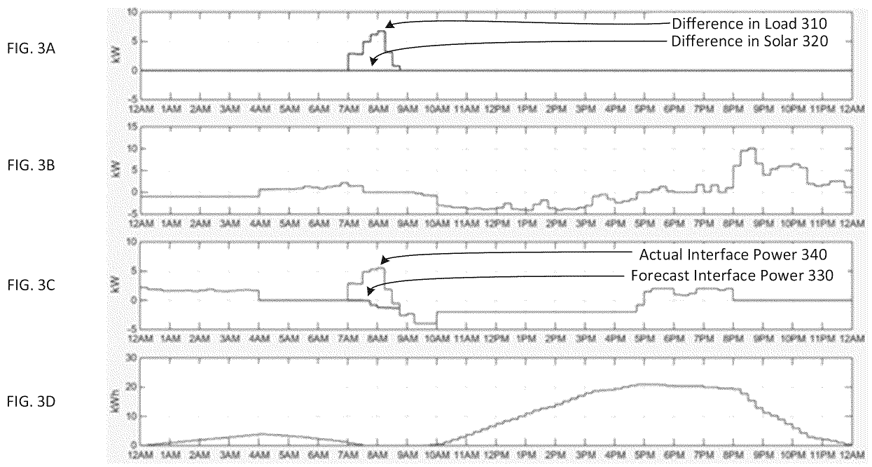

FIGS. 3A to 3D depict a hypothetical example of real time adjustment, consistent with disclosed embodiments. These figures concern a node including a battery and a solar power generation source. The node is also connected to a main power source (e.g., a community node or the like). The node is configured to respond to an increased load by drawing additional power from the main power source.

FIG. 3A depicts the differences between the forecast and actual real-time load for a local node (Difference in Load 310) and the difference between the forecast and actual real-time solar power generation (Difference in Solar 320). In this case, a large, unexpected load peak is present between 7 am and 8:45 am. In the meantime, the Difference in Solar 320 between the forecast and available solar power remains zero. Thus there is no additional solar power that can be used to compensate for Difference in Load 310.

FIG. 3B depicts the effect of the increase in load on the forecasted and actual battery power provided by the battery in the node. Even though there is a load greater than the forecasted load, the real battery power is similar to the forecasted one (they appear as a single line). This is because the correction method of FIG. 1 adjusts the power exchanged with the main grid to compensate for the increased load.

FIG. 3C depicts the change in power exchanged with the main power source during the high load demand is shown in the third plot. Forecast Interface Power 330 is lower than the Actual Interface Power 340 during the interval of unexpectedly high loads. This difference is due to the application of rules that increase the power exchanged with the main power source when the load exceeds the forecast amount.

FIG. 3D depicts the forecast and actual state of charge of the battery. Similar to FIG. 3B, these two values overlap due to the compensation provided according to method 100. As depicted in FIG. 3D, the desired state of change can vary over the course of the day (e.g., as a result of optimizations determined by the controller of the node). The method of FIG. 1 can then ensure that the actual state of charge tracks the desired state of charge.

The corrections can be executed locally in the node and no re-forecasting or additional communication is needed. The specific algorithm of how the conditions are recovered can be changed to produce the best response. In other words, several different actions can be taken to recover the power or state of charge of the energy storage; in addition, the storage parameters may be allowed to drift from the forecast within some limits all within the real time correction concept.

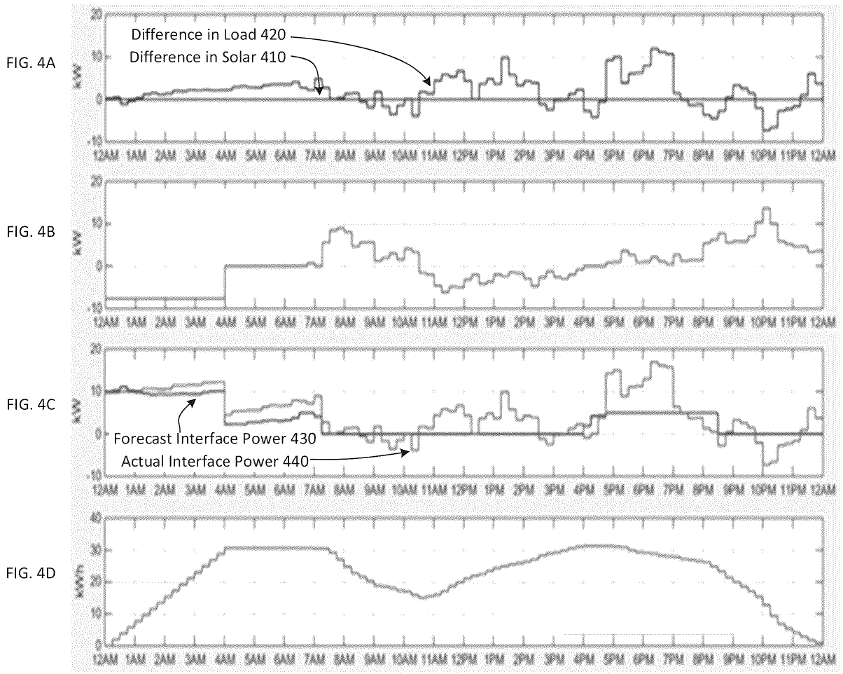

FIG. 4A depicts an instance in which the load on a local node varies from the forecasted load (e.g., the Different in Load 420 is non-zero) throughout the interval. In contrast, the actual solar power matches the forecast solar power (e.g., the Difference in Solar 410 is zero) throughout the interval. As depicted in FIG. 4C, in response to these differences, Actual Interface Power 440 (e.g., the power transferred to the local node across a power connection from a community node, power source, or the like) is adjusted throughout the interval, according to the method described above with regards to FIG. 1. Thus Actual Interface Power 440 differs from Forecast Interface Power 430 over the interval. As a result of this adjustment, the actual battery power provided by a battery in the local node remains the same as the forecasted battery power (e.g., as shown by the single line in FIG. 4B). Furthermore, the state of charge of the battery follows the forecast trajectory (e.g., as shown by the single line in FIG. 4D). In this case, the correction is continuously acting to bring the system back to the forecasted operation with the result in the last plot being a perfect match between forecasted and real values.

### Energy Allocation

Sophisticated energy storage applications are becoming practical as energy storage devices improve in performance and decrease in price. In some applications, such as microgrids, an energy storage device may be relied upon to perform multiple functions. Such reliance can complicate the design and operation of the energy storage device. In particular, operation of the device may require satisfaction of different, potentially contradictory performance goals associated with different functions. Operation of the energy storage device may further be complicated when the device is part of a system designed to use energy storage to accommodate average load requirements (e.g., instead of peak load requirements). In such systems, the energy storage device may have a primary function of provide (or storing) the difference between the current power supplied to the system and the current load drawn on the system. DC microgrids are a typical example of this situation. In such systems, use of energy for secondary functions could impair the ability of the system to accommodate increases in the load drawn on the system, potentially causing the system to fail. On the other extreme, reserving too much energy to accommodate increases in the load drawn on the system can result in an inefficient under-utilization of the energy storage device.

### Energy Allocation Method

Consistent with disclosed embodiments, an energy storage device can be configured to manage energy storage for multiple functions. Different functions can be assigned different priorities. Energy storage capacity can be reserved for each function by order of priority, from highest priority to lowest priority. For example, when the primary function of an energy storage device is to accommodate differences between average and peak power, the energy storage capacity to satisfy this function can be reserved first. The remaining energy storage capacity can be allocated between other functions. In this manner, the most critical performance functions “book” their energy needs first, and the spare capacity gets assigned based on the priority.

Because the primary needs of the energy storage device are expressly accounted for, the system can have more flexibility to accommodate secondary functions. Thus more energy storage capacity can be allocated to those functions, without risk of overusing stored energy in support of a low priority function and then running out of stored energy for performance of the primary function. Furthermore, the system can forecast the amount of energy required for primary and secondary functions. The system can then modify a configuration of the system (e.g., by requesting additional power from a community node, power source, or the like; or by load shedding, demand management, load rescheduling, or the like) to ensure that desired amounts of energy are available at future times, both for the primary and secondary functions performed by the energy storage device. This forecasted energy assignment can be performed in advance and can be adjusted in real time as the operating conditions change resulting in a flexible and dynamic use of the energy. For example, the amount of energy available for a primary or secondary function can be part of the state of a node. As part of the state of a node, these amounts can be managed according to the method described above with regards to FIG. 1.

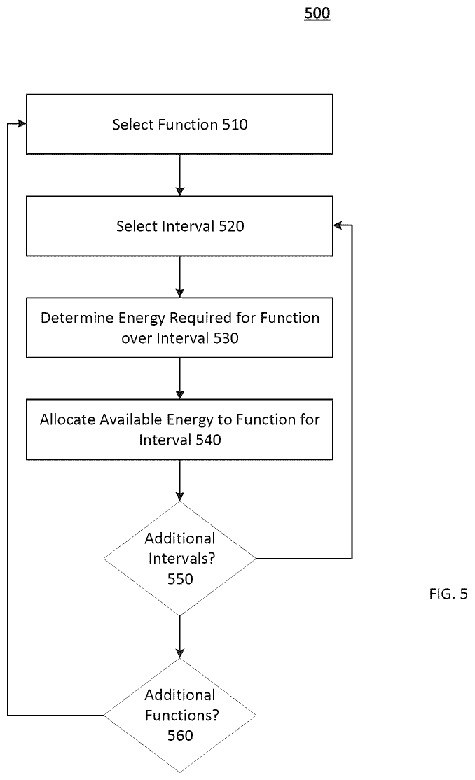

FIG. 5 depicts an exemplary method 500 for allocating stored energy, consistent with disclosed embodiments. Method 500 can be performed by a node that includes energy storage, such as the local node or community node described above with regards to FIG. 2. For example, method 500 can be performed by a DC microgrid configured to use an energy storage device as a balancing element or buffer for the renewable generation, the loads, and the main energy source (grid), such as the DC microgrid depicted in FIG. 2.

Consistent with disclosed embodiments, a controller of the node can obtain functions for the node. In some embodiments, the controller of the node can be configured with the functions. For example, the controller for the node can be programmed to perform the functions. In some embodiments, such programming can be performed prior to installation of the controller or creation of the node (e.g., a controller can be factory-programmed, or the like), locally (e.g., through a user interface of a computer interface such as an RS 232 port, USB port, Bluetooth interface, wireless interface, or the like), over a network (e.g., using instructions received by the controller), or another suitable manner. In some embodiments, the functions may be implemented as aspects or features of software for managing the node. In some embodiments, the controller of the node can be configured with multiple functions. A user can interact with the node to enable or disable performance of these functions. The user can interact with the node through a local interface or over a network to enable or disable performance of the functions. In some embodiments, the controller can retrieve or receive the functions from another system or device (e.g., over a network).

Consistent with disclosed embodiments, the functions can concern the needs and requirements of the node, the overall power system of which the node is a part, or a combination thereof. An example first function can be load leveling. The energy storage device can be configured to ensure that instantaneous load requirements can be satisfied, while maintaining the power imported from a community node (or power grid) at less than a specified maximum level. An example second function can be storage of reserve power, enabling the system to draw power from an intermittent power source, such as a renewable energy source. An example third function can be increasing the usage of an intermittent power source, such as a solar array or wind turbine. The third function can be distinguished from the second function in that the second function can be satisfied so long as a sufficient reserve of energy is maintained, while the third function may seek to maximize the amount of power drawn from the intermittent power source. A fourth function can be providing stored energy to another system. For example, when the system is a local node, this could include returning power to a community node or power grid. As an additional example, when the system is a community node, this could include powering other local nodes. The performance of each of these functions may require a certain amount of the capacity of the energy storage device.

Consistent with disclosed embodiments, priorities can be associated with the functions. In some embodiments, the priorities can be specified based on the importance of the function to the intended operation of the node. For example, the first function described above may have the highest priority, as failure to ensure that instantaneous load requirements are satisfied (or drawing more power from the community node or grid than the power connection can handle) can negatively affect the node or loads dependent on the node. The second function may have the next highest priority. While not as critical as ensuring that instantaneous load requirements are satisfied (e.g., because the node may be able to request additional power from the community node or grid), failure to maintain a sufficient reserve power could cause the node to fail. The third and fourth functions may have lower priority than the first and second functions. These functions may allow the node to maximize use of cheaper renewable energy or sell energy back to the grid. In this example, the third function may be higher priority than the fourth function, but this ranking is not intended to be limiting and could depend upon the operator of the node. As may be appreciated, failing to maximize the amount of intermittent power used or failing to share power with the grid may have monetary consequences, but will not necessarily affect the performance of the node.

In some embodiments, the functions may be divided between performance functions (e.g., those that affect the performance of the node) and value functions (e.g., those that provide an opportunity to obtain additional value from the node, such as by providing energy back to the grid or maximizing use of renewable energy). Performance functions may be afforded a higher priority than value functions.

In some embodiments, priorities can be periodically re-determined. For example, a node may assign a first value function priority over a second value function at a first time. The node may then assign the second value function priority over the first value function at a second time (e.g., a day later, a week later, a month later, or the like).

Consistent with disclosed embodiments, method 500 can be performed according to a schedule (e.g., periodically). For example, method 500 can be performed daily, weekly, monthly, or the like. Consistent with disclosed embodiments, method 500 can be performed in response to an event. Such an event could be or include receipt of instructions (e.g., as described with regards to step 110 of method 100). Such an event could be or include a determination that a state of a node was outside of a tolerance (e.g., as described with regards to step 140 of method 100). Such an event could be or include prompting by a user of the node. For example, a user could interact with the node through a user interface to instruct the node to perform method 500. Such an event could include a request from another node. For example, a community node could request that a local node return power to the grid.

In step 510 of method 500, one of the functions available for the node can be selected. In some embodiments, a controller of the node can select the function. The function can be selected from among the functions configured for the node. In some embodiments, the function can be selected from among enabled functions configured for the node. The function can be selected based on a priority of the function. For example, the selected function can be the highest priority function.

In step 520 of method 500, a time interval can be selected. In some embodiments, the time interval can be selected by a controller of the node. The selected time interval can be a portion of an overall duration. For example, as described above with regards to FIG. 1, a high-level controller (or a community node, or the like) for a power system can provide instructions to a node of the power system. The instructions, when implemented by the node, can cause the node to participate in an overall dispatch plan for the power system. These instructions can correspond to a duration and specify the actions of the node over that duration. In some embodiments, the overall duration can be a period of an hour, 6 hours, 12 hours, 24 hours, a week, two weeks, a month, three months, six months, a year, or the like. In various embodiments, the time interval can be sufficiently short to enable performance of the functions of the node. For example, the time interval should not be so long that the battery, under a worst-case scenario, can be completely drained between time intervals. In various embodiments, the time interval should be sufficiently long that the controller is not burdened with too many time intervals. For example, when the overall duration is a day, the time interval should be greater than microseconds. For example, the time interval can be a minute, 6 minutes, 15 minutes, 30 minutes, an hour, a day, a week, a month, or another suitable time interval, depending on the components of the node.

In some embodiments, the selected time interval can be the next time interval. For example, the controller can select the first time interval in the duration and then progress through subsequent time intervals until all time intervals in the duration have been addressed.

In step 530 of method 500, the energy required for the selected function during the selected interval can be determined. The disclosed embodiments are not limited to any particular method for determining the power required for the function over the interval. In some embodiments, the amount of power required could depend on at least one of the present or forecasted state of the node. For example, when the function is maintaining the ability to provide instantaneous power for anticipated loads, the amount of energy required can depend on the forecast power received from the grid or community node and the forecast loads. The amount of energy required can also depend upon the capabilities of the node (e.g., the ability of the node to replenish the energy storage device by drawing power in excess of instantaneous power required to satisfy present loads, or the presence or absence of additional power sources useable to replenish the energy storage device). As an additional example, the energy required can depend upon historical data (e.g., historical load or power generation data, or the like) concerning the node. For example, when the function is maintaining a reserve in case of underperformance by an intermittent power source (e.g., a solar array or wind turbine), the amount of energy required can be determined by evaluating historical energy yield patterns for the intermittent power source. In some embodiments, these historical patterns can be used to generate a statistical model of the intermittent power source. This statistical model can be used in conjunction with a forecast of the state of the node to determine a minimum amount of reserved energy required to ensure that the probability of fully depleting the energy storage device (or of being unable to provide the power requested by the loads) is less than a specified probability. For example, when the intermittent power source is a wind turbine, the controller might determine that ensuring a steady provision of power, given anticipated loads, in spite of a 1-in-100-year calm spell, would require reserving 20% of battery capacity.

In step 540, available energy storage capacity can be allocated to the function. In some embodiments, the controller for the node can determine whether the energy storage device has sufficient capacity for the function. The controller can be configured to determine whether the available capacity in the energy storage device is greater than (or less than or equal to) the required energy determined in step 530. In some embodiments, the controller can track previously allocated energy. The controller can compare the sum of the required energy determined in step 530 and the previously allocated energy to the total capacity of the energy storage system. If the sum is less than the total capacity of the energy storage system, then the value of allocated energy can be updated to equal the value of the sum. The required energy determined in step 530 can be allocated to the selected function in the selected interval. For example, if the previously allocated energy is 10 kW hours, the energy calculated in step 530 is 2 kW hours, and the total capacity is 14 kW hours, then 2 kW hour can be allocated to the function in that interval and the allocated energy can be updated to 12 kW hours. In some embodiment, if the sum is greater than or equal to the total capacity then the difference between the previously allocated energy and the total available energy can be allocated to the selected function in the selected interval. For example, if the previously allocated energy is 10 kW hours, the energy calculated in step 530 is 2 kW hours, and the total capacity is 11 kW hours, then 1 kW hour can be allocated to the function in that interval. The total allocated energy can then be updated to 11 kW hours. In this manner, the system can ensure that energy capacity in the energy storage system is always available for the performance of higher priority functions.

In step 550, the node can determine whether additional intervals remain. For example, when the selected interval is the first interval of one hundred intervals, method 500 can then return to step 520 and select the second interval.

In step 560, the node can determine whether additional functions remain. For example, when the selected function is the second function of three functions. method 500 can then return to step 510 and select the third function.

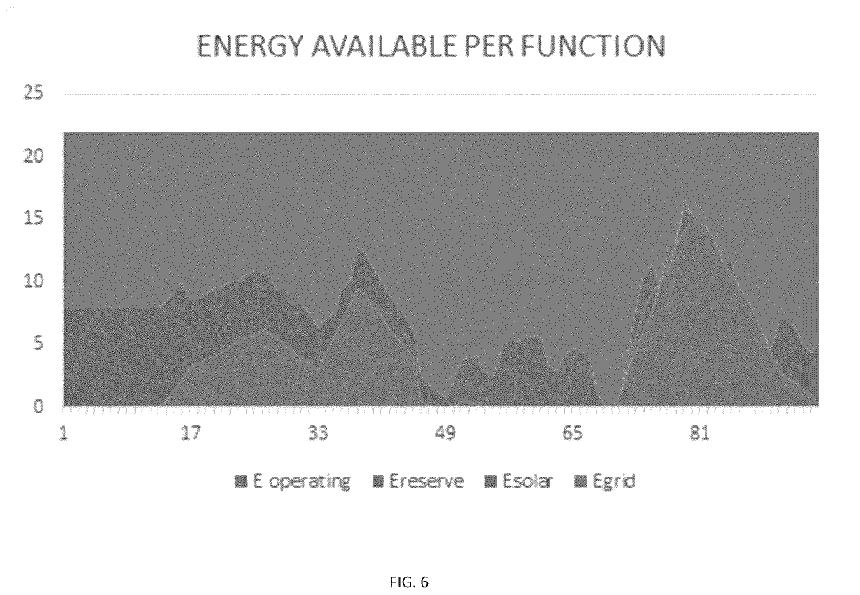

FIG. 6. depicts an exemplary allocation of energy capacity among four different functions: A first function for ensuring that the instantaneous load requirements are satisfied (e.g., eOperating). A second function for ensuring that reserve power is satisfied, enabling use of an intermittent power source to offset usage of the main grid (e.g., eReserve). A third function of obtaining and storing the most solar power possible (e.g., eSolar), and a fourth function of providing power back to the grid to support the operations of the grid (e.g. eGrid). In this example, the x axis is duration, divided into intervals from 1 to 96, each interval lasting 15 min. Thus the duration is a full day, beginning at 12 AM and ending at 11:59:59 PM. The y axis is energy (e.g., in kilowatt hours). Thus each region represents a portion of the total energy capacity of the energy storage device.

Consistent with disclosed embodiments, the controller has estimated the amount of energy required to perform each of the four functions, based on the historical load and solar values (e.g., of this node or of similar nodes). As depicted in FIG. 6, energy capacity is reserved for the eOperating function during two periods of heavy loads in the morning and evening. Energy capacity is reserved at night to account for the shortfall in solar power at that time (e.g., the eReserve function). Energy capacity is reserved in the middle of the day for storing as much excess solar power as possible (e.g., the eSolar function). The remaining capacity is available to support the grid (e.g., the eGrid function).

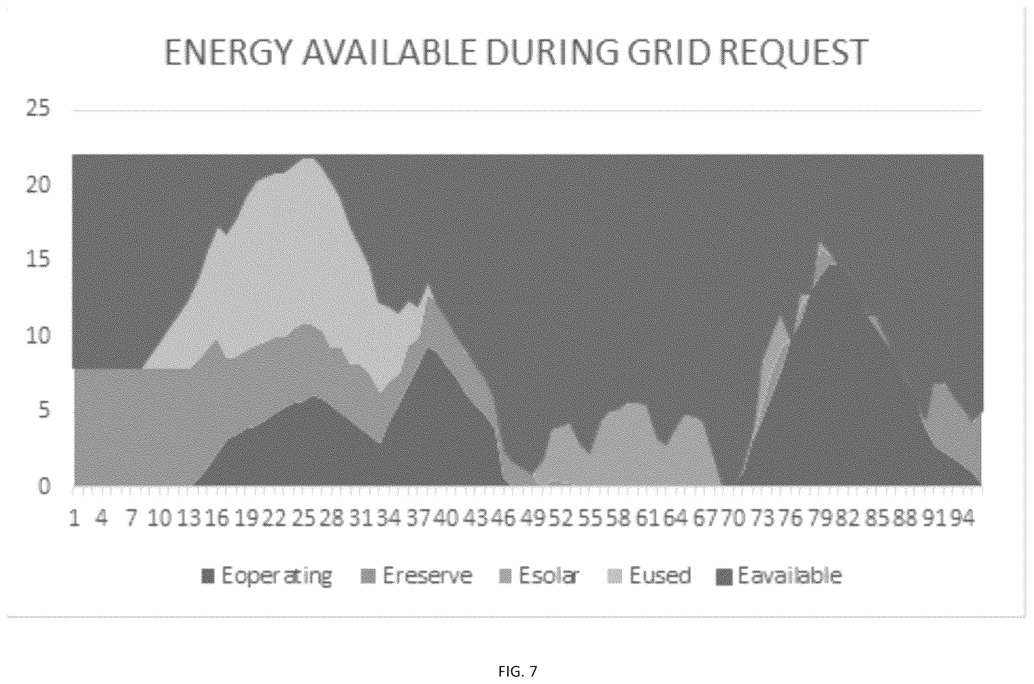

FIG. 7 depicts an updated version of the chart of FIG. 6. In this example, the node has received instructions to provide 3 hours of support to the grid, starting at interval 10 (e.g., intervals 10 to 22). The node can determine the amount of power that can be provided to the grid such that the energy capacity allocated to grid support does not exceed the available energy capacity. For example, the node may discharge the energy storage device to provide grid support between interval 10 and 22. The energy capacity required to perform that function is representing as an increasing area in FIG. 7 from interval 10 to 22. Once the period of grid support is complete, the node can recharge the energy storage device until it is fully recharged. Such recharging is not instantaneous and the rate at which the energy storage device is recharged can depend upon the excess power capacity available to the node. Accordingly, the energy capacity required to perform the grid support function is representing as a decreasing area in FIG. 7 from interval 10 to approximately interval 37. As may be appreciated, the amount of grid support provided can be determined based on the forecast state of the node, such that the total energy capacity of the system is not exceeded either during the discharging or recharging of the energy storage device.

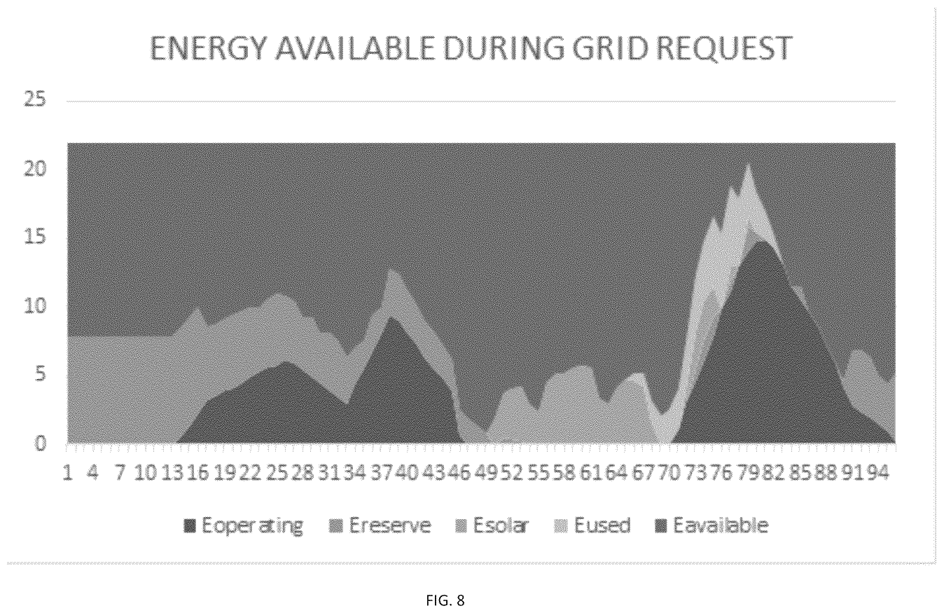

FIG. 8 depicts a chart indicating the energy dedicated to each function when there is a request from the grid to provide 3 hours of support starting from interval 66 (e.g., intervals 66 to 78). In this example, the controller of the node anticipates substantial local power usage between intervals 70 and 91. Accordingly, when energy capacity was allocated, as described above according to method 500, relatively little capacity was allocated for grid support around interval 79. Accordingly, assuming in this case that the power provided is consistent over the three hours, this power is limited by the available capacity around interval 79 (where the capacity required to provide grid support reaches its maximum). Thereafter, the capacity required to provide grid support diminishes, as the battery is recharged. Accordingly, in this example, the amount of energy that node can provide is smaller, but the system can calculate the best support it can give without violating the other priorities.

As may be appreciated, power usage or requests implicating other functions can be managed accordingly. For example, usage of battery capacity for performing the reserve power can be tracked. In a manner like that depicted in FIGS. 7 and 8, this usage can be managed to ensure that it stays within the band allocated for the eReserve function. For example, the node can reschedule loads or engage in load shedding to ensure that the allocated reserve power is not used up too quickly.

In FIGS. 6 to 8, the total amount of energy capacity was fixed over the 24-hour period. However, the disclosed embodiments are not limited to such instances. In some embodiments, the total energy capacity can change overtime. For example, the node can be configured to charge up at night and discharge during the day. To continue this example, the total capacity could be 21 kW hours between intervals 1 to 10, decrease to 15 kW hours by interval 40, remain at 15 kW hours between intervals 40 and 60, increase to 21 kW hours between intervals 60 and 80, and remain at 21 kW hours between intervals 80 and 96. The controller could then allocate energy to functions such that the allocated energy fits within this overall, time-dependent capacity bound.

The foregoing description has been presented for purposes of illustration. It is not exhaustive and is not limited to precise forms or embodiments disclosed. Modifications and adaptations of the embodiments will be apparent from consideration of the specification and practice of the disclosed embodiments. For example, the described implementations include hardware, but systems and methods consistent with the present disclosure can be implemented with hardware and software. In addition, while certain components have been described as being coupled to one another, such components may be integrated with one another or distributed in any suitable fashion.

Moreover, while illustrative embodiments have been described herein, the scope includes any and all embodiments having equivalent elements, modifications, omissions, combinations (e.g., of aspects across various embodiments), adaptations or alterations based on the present disclosure. The elements in the claims are to be interpreted broadly based on the language employed in the claims and not limited to examples described in the present specification or during the prosecution of the application, which examples are to be construed as nonexclusive. Further, the steps of the disclosed methods can be modified in any manner, including reordering steps or inserting or deleting steps.

The features and advantages of the disclosure are apparent from the detailed specification, and thus, it is intended that the appended claims cover all systems and methods falling within the true spirit and scope of the disclosure. As used herein, the indefinite articles “a” and “an” mean “one or more.” Similarly, the use of a plural term does not necessarily denote a plurality unless it is unambiguous in the given context. Further, since numerous modifications and variations will readily occur from studying the present disclosure, it is not desired to limit the disclosure to the exact construction and operation illustrated and described, and accordingly, all suitable modifications and equivalents may be resorted to, falling within the scope of the disclosure.

As used herein, unless specifically stated otherwise, the term “or” encompasses all possible combinations, except where infeasible. For example, if it is stated that a component may include A or B, then, unless specifically stated otherwise or infeasible, the component may include A, or B, or A and B. As a second example, if it is stated that a component may include A, B, or C, then, unless specifically stated otherwise or infeasible, the component may include A, or B, or C, or A and B, or A and C, or B and C, or A and B and C.

The embodiments may further be described using the following clauses:

1. A controller for managing power transfer in a distributed power transmission system, comprising: at least one processor; and at least one memory storing instructions that, when executed by the at least one processor, cause the controller to perform operations comprising: receiving a forecast trajectory for a power node; determining a measured trajectory for the power node; determining an error signal using the forecast trajectory and the measured trajectory; providing instructions to reduce the error signal: to a smart interface controller to transfer energy between the power node and at least one power system connected to the power node; and to transfer energy between the power node and an energy storage device connected to the power node.

2. The controller of clause 1, wherein: the forecast trajectory includes a forecast trajectory of the state of charge of the energy storage device; and the measured trajectory includes a measured trajectory of the state of charge of the energy storage device.

3. The controller of clause 1, wherein: the forecast trajectory includes a forecast trajectory of current drawn by loads connected to the power node or provided by power sources connected to the power node; and the measured trajectory includes a measured trajectory of current drawn by loads connected to the power node or provided by power sources connected to the power node.

4. The controller of clause 1, wherein: determining the error signal comprises applying a deadband function to a difference between the forecast trajectory and measured trajectory.

5. The controller of clause 1, wherein the forecast trajectory includes one or more operating parameters of the power node over time for a future time period, and wherein the measured trajectory includes matching operating parameters of the power node measured overtime during a present time period corresponding to the future time period.

6. The controller of clause 1, wherein the distributed power transmission system comprises two or more power nodes, and wherein the controller performs the operations for a particular power node independent of the other power nodes.

7. The controller of clause 1, wherein the forecast trajectory is specific to operating conditions of the power node for a particular time period, wherein the power node is a particular power node among two or more power nodes connected to the distributed power transmission system.

8. The controller of clause 1, wherein the error signal is determined based on a difference between the forecast trajectory and the measured trajectory that exceeds a predetermined threshold.

9. A controller for managing energy allocation in a distributed power transmission system, comprising: at least one processor; and at least one memory storing instructions that, when executed by the at least one processor, cause the controller to perform operations comprising: receive tasks and corresponding priorities for a power node; and for an interval: iteratively in priority order for each task: determine an energy requirement amount for the task; and when the energy requirement amount is less than an available energy amount: allocate the energy requirement amount to the task; and update the available energy amount based on a total available energy amount and the energy requirement amount; and provide instructions to: a smart interface controller to transfer power between the power node and at least one power system connected to the power node; based on a first energy requirement amount allocated to a first task of ensuring an energy supply to loads connected to the power node; and transfer energy between the power node and an energy storage device connected to the power node, based on a second energy requirement amount allocated to a second task of maintaining the energy storage device on a stored energy trajectory.

10. The controller of clause 9, wherein the distributed power transmission system comprises two or more power nodes, and wherein the controller performs the operations for a particular power node independent of the other power nodes.

11. The controller of clause 9, wherein the energy requirement amount for each task is variable between each interval based on an assessment of operating status of the power node.

12. The controller of clause 9, wherein the energy requirement amounts for the tasks are determined based on a forecast trajectory.

13. The controller of clause 12, wherein the operations further comprise, for the interval, determining overhead energy amounts for the tasks based on a history of energy consumption that deviated from the forecast trajectory.

14. The controller of clause 9, wherein the tasks include transferring power to the at least one power system; transferring energy to the energy storage device; or spending power on one or more subsystems connected to the power node.

15. The controller of clause 9, wherein the power transferred to the at least one power system is based on an actual load drawn by the loads connected to the power node and less than the first energy requirement amount.

16. The controller of clause 9, wherein the energy transferred to the energy storage device is based on an actual load requested by the energy storage device and less than the second energy requirement amount.

17. The controller of clause 9, wherein the operations further comprise, for the interval, storing a remaining energy amount in a power reserve, wherein the remaining energy amount is a difference between the total available energy amount and the sum of the energy requirement amounts for the tasks.

18. The controller of clause 17, wherein the operations further comprise, for the interval, transferring energy corresponding to a remaining energy amount to the distributed power transmission system, wherein the remaining energy amount is a difference between the total available energy amount and the sum of the energy requirement amounts for the tasks.

The embodiments may further be described using the following additional clauses:

1. A controller for a power system, comprising: at least one processor; and at least one memory storing instructions that, when executed by the at least one processor, cause the controller to perform operations for correcting a state of a first node of the power system, the operations comprising: obtaining rules for correcting the state of the first node, each rule specifying a corrective action for the first node; obtaining instructions for the first node, the instructions at least partially specifying a configuration of the first node; generating a forecast of the state of the first node based on the instructions; monitoring the state of the first node; and based on the forecast state and the monitored state of the first node: selecting one of the rules; and applying the corrective action specified by the selected one of the rules to correct the state of the first node.

2. The controller of clause 1, wherein: the state of the first node includes variables corresponding to a status or configuration of the first node; and selecting the one of the rules comprises: comparing the monitored state and forecast state of the first node; and determining a difference between the forecast state and monitored state, the determined difference being for one of the variables, for a combination of the variables, or for a trajectory of the state.

3. The controller of clause 2, wherein: each of the obtained rules corresponds to a difference for one of the variables, for a combination of the variables, or for the trajectory of the state; and the one of the rules is selected based on the determined difference.

4. The controller of any one of clauses 1 to 3, wherein: the one of the rules is selected based on: a previous selection by the controller of another one of the rules; or a magnitude of a difference between the forecast state and monitored state.

5. The controller of any one of clauses 1 to 4, wherein: the corrective action comprises: changing a configuration of a power connection of the first node; changing a rate of charging or discharging of an energy storage device of the first node; or load shedding or load rescheduling.

6. The controller of any one of clauses 1 to 5, wherein: the instructions specify that the first node be configured to receive differing amounts of power over a time interval.

7. The controller of any one of clauses 1 to 6, wherein: the state includes a state of charge, temperature, or average or instantaneous power transfer of an energy storage device of the first node.

8. The controller of any one of clauses 1 to 7, wherein: the operations further comprise updating the forecast state of the first node based on the application of the corrective action.

9. The controller of any one of clauses 1 to 8, wherein: the forecast is generated based on historical information of the first node concerning: loads drawn from the first node; power received from an intermittent power source connected to the first node; or power received from a main power source connected to the first node.

10. The controller of any one of clauses 1 to 9, wherein: the instructions are received, using power line communications, through a power connection of the first node.

11. A method performed by a controller for correcting a state of a first node of a power system, comprising: obtaining rules for correcting the state of the first node, each rule specifying a corrective action for the first node; obtaining instructions for the first node, the instructions at least partially specifying a configuration of the first node; generating a forecast of the state of the first node based on the instructions; monitoring the state of the first node; and based on the forecast state and the monitored state of the first node: selecting one of the rules; and applying the corrective action specified by the selected one of the rules to correct the state of the first node.

12. The method of clause 11, wherein: the state of the first node includes variables corresponding to a status or configuration of the first node; and selecting the one of the rules comprises: comparing the monitored state and forecast state of the first node; and determining a difference between the forecast state and monitored state, the determined difference being for one of the variables, for a combination of the variables, or for a trajectory of the state.

13. The method of clause 12, wherein: each of the obtained rules corresponds to a difference for one of the variables, for a combination of the variables, or for the trajectory of the state; and the one of the rules is selected based on the determined difference.

14. The method of any one of clauses 11 to 13, wherein: the one of the rules is selected based on: a previous selection by the controller of another one of the rules; or a magnitude of a difference between the forecast state and monitored state.

15. The method of any one of clauses 11 to 14, wherein: the corrective action comprises: changing a configuration of a power connection of the first node; changing a rate of charging or discharging of an energy storage device of the first node; or load shedding or load rescheduling.

16. The method of any one of clauses 11 to 15, wherein: the instructions specify that the first node be configured to receive differing amounts of power over a time interval.

17. The method of any one of clauses 11 to 16, wherein: the state includes a state of charge, temperature, or average or instantaneous power transfer of an energy storage device of the first node.

18. The method of any one of clauses 11 to 17, wherein: the method further comprises updating the forecast state of the first node based on the application of the corrective action.

19. The method of any one of clauses 11 to 18, wherein: the forecast is generated based on historical information of the first node concerning: loads drawn from the first node; power received from an intermittent power source connected to the first node; or power received from a main power source connected to the first node.

20. The method of any one of clauses 11 to 19, wherein: the instructions are received, using power line communications, through a power connection of the first node.

21. A controller for a node in a power system, comprising: at least one processor; and at least one memory storing instructions that, when executed by the at least one processor, cause the controller to perform operations comprising: obtaining functions and corresponding priorities; allocating, in an energy storage device of the node, time-dependent energy storage capacities for the functions based on the priorities, allocation comprising: selecting a function based on the corresponding priorities; selecting a time interval; determining an energy requirement amount for the selected function in the selected time interval; and determining that the energy requirement amount is less than an available energy capacity of the energy storage device and, in response to the determination, allocating an amount of available energy capacity in the energy storage device to performance of the function during the time interval; determining, in response to a request to perform a first function, an amount of power transferable from the energy storage device based on a time-dependent energy storage capacity for the first function; and providing instructions to configure the node to transfer the determined amount of power from the energy storage device.

22. The controller of clause 21, wherein the functions include primary and value functions, the priorities of the primary functions being higher than the priorities of the value functions.

23. The controller of any one of clauses 21 to 22, wherein the energy requirement amount for the selected function in the selected time interval depends upon a forecast state of the node.

24. The controller of any one of clauses 21 to 23, wherein the energy requirement amount for the selected function in the selected time interval depends upon historical power generation or load data.

25. The controller of any one of clauses 21 to 24, wherein: determining the amount of power transferable comprises determining that: a net energy transferred during the performance of the requested function is less than the allocated energy capacity for the function during the performance of the function; and the net energy transferred during recovery from the performance of the function is less than the allocated energy capacity for the function during recovery from the performance of the function.

26. The controller of any one of clauses 21 to 25, wherein the time-dependent energy storage capacities are defined over an overall duration of 24 hours or a week; and the time interval is a minute, 6 minutes, 15 minutes, 30 minutes, or an hour.

27. The controller of any one of clauses 21 to 26, wherein the functions include: maintaining a reserve in case of underperformance by an intermittent power source; providing instantaneous power for anticipated loads; or increasing consumption of power from the intermittent power source.

28. The controller of any one of clauses 21 to 27, wherein the request specifies a start time and duration of the performance of the first function.

29. The controller of any one of clauses 21 to 28, wherein the request is received from another node or a controller for the power system.

30. The controller of any one of clauses 21 to 29, wherein the first function is a grid support function.

31. A method performed by a controller of a node of a power system for allocating power in an energy storage device of the node, comprising: obtaining functions and corresponding priorities; allocating, in the energy storage device, time-dependent energy storage capacities for the functions based on the priorities, allocation comprising: selecting a function based on the corresponding priorities; selecting a time interval; determining an energy requirement amount for the selected function in the selected time interval; and determining that the energy requirement amount is less than an available energy capacity of the energy storage device and, in response to the determination, allocating an amount of available energy capacity in the energy storage device to performance of the function during the time interval; determining, in response to a request to perform a first function, an amount of power transferable from the energy storage device based on a time-dependent energy storage capacity for the first function; and providing instructions to configure the node to transfer the determined amount of power from the energy storage device.

32. The controller of clause 31, wherein the functions include primary and value functions, the priorities of the primary functions being higher than the priorities of the value functions.

33. The controller of any one of clauses 31 to 32, wherein the energy requirement amount for the selected function in the selected time interval depends upon a forecast state of the node.

34. The controller of any one of clauses 31 to 33, wherein the energy requirement amount for the selected function in the selected time interval depends upon historical power generation or load data.

35. The controller of any one of clauses 31 to 34, wherein: determining the amount of power transferable comprises determining that: a net energy transferred during the performance of the requested function is less than the allocated energy capacity for the function during the performance of the function; and the net energy transferred during recovery from the performance of the function is less than the allocated energy capacity for the function during recovery from the performance of the function.

36. The controller of any one of clauses 31 to 35, wherein the functions include: maintaining a reserve in case of underperformance by an intermittent power source; providing instantaneous power for anticipated loads; or increasing consumption of power from the intermittent power source.

37. The controller of one of clauses 31 to 36, wherein the time-dependent energy storage capacities are defined over an overall duration of 24 hours or a week; and the time interval is a minute, 6 minutes, 15 minutes, 30 minutes, or an hour.

38. The controller of one of clauses 31 to 37, wherein the request specifies a start time and duration of the performance of the first function.

39. The controller of one of clauses 31 to 38, wherein the request is received from another node or a controller for the power system.

40. The method of one of clauses 31 to 39, wherein the first function is a grid support function.

Other embodiments will be apparent from consideration of the specification and practice of the embodiments disclosed herein. It is intended that the specification and examples be considered as example only, with a true scope and spirit of the disclosed embodiments being indicated by the following claims.

What is claimed is:

1. A controller for a power system, comprising:
at least one processor; and
at least one memory storing instructions that, when executed by the at least one processor, cause the controller to perform operations for correcting a state of a first node of the power system, the operations comprising:
obtaining rules for correcting the state of the first node, each rule specifying a corrective action for the first node;
obtaining instructions for the first node, the instructions at least partially specifying a configuration of the first node;
generating a forecast of the state of the first node based on the instructions;
monitoring the state of the first node; and
based on the forecast state and the monitored state of the first node:
selecting one of the rules; and
applying the corrective action specified by the selected one of the rules to correct the state of the first node.

2. The controller of claim 1, wherein the state of the first node includes variables corresponding to a status or configuration of the first node and wherein selecting the one of the rules comprises:
comparing the monitored state and forecast state of the first node; and
determining a difference between the forecast state and monitored state, the determined difference being for one of the variables, for a combination of the variables, or for a trajectory of the state.

3. The controller of claim 2, wherein:
each of the obtained rules corresponds to a difference for one of the variables, for a combination of the variables, or for the trajectory of the state; and
the one of the rules is selected based on the determined difference.

4. The controller of claim 1, wherein the one of the rules is selected based on:
a previous selection by the controller of another one of the rules; or
a magnitude of a difference between the forecast state and monitored state.

5. The controller of claim 1, wherein the corrective action comprises:
changing a configuration of a power connection of the first node;
changing a rate of charging or discharging of an energy storage device of the first node; or
load shedding or load rescheduling.

6. The controller of claim 1, wherein the instructions specify that the first node be configured to receive differing amounts of power over a time interval.

7. The controller of claim 1, wherein the state includes a state of charge, temperature, or average or instantaneous power transfer of an energy storage device of the first node.

8. The controller of claim 1, wherein the operations further comprise updating the forecast state of the first node based on the application of the corrective action.

9. The controller of claim 1, wherein the forecast is generated based on historical information of the first node concerning:
loads drawn from the first node;
power received from an intermittent power source connected to the first node; or
power received from a main power source connected to the first node.

10. The controller of claim 1, wherein the instructions are received, using power line communications, through a power connection of the first node.

11. A method performed by a controller for correcting a state of a first node of a power system, comprising:
obtaining rules for correcting the state of the first node, each rule specifying a corrective action for the first node;
obtaining instructions for the first node, the instructions at least partially specifying a configuration of the first node;
generating a forecast of the state of the first node based on the instructions;
monitoring the state of the first node; and
based on the forecast state and the monitored state of the first node:
selecting one of the rules; and
applying the corrective action specified by the selected one of the rules to correct the state of the first node.

12. The method of claim 11, wherein the state of the first node includes variables corresponding to a status or configuration of the first node; and
selecting the one of the rules comprises:
comparing the monitored state and forecast state of the first node; and
determining a difference between the forecast state and monitored state, the determined difference being for one of the variables, for a combination of the variables, or for a trajectory of the state.

13. The method of claim 12, wherein each of the obtained rules corresponds to a difference for one of the variables, for a combination of the variables, or for the trajectory of the state; and
the one of the rules is selected based on the determined difference.

14. The method of claim 11, wherein the one of the rules is selected based on:
a previous selection by the controller of another one of the rules; or
a magnitude of a difference between the forecast state and monitored state.

15. The method of claim 11, wherein the corrective action comprises:
changing a configuration of a power connection of the first node;
changing a rate of charging or discharging of an energy storage device of the first node; or
load shedding or load rescheduling.

16. The method of claim 11, wherein the instructions specify that the first node be configured to receive differing amounts of power over a time interval.

17. The method of claim 11, wherein the state includes a state of charge, temperature, or average or instantaneous power transfer of an energy storage device of the first node.

18. The method of claim 11, wherein the method further comprises updating the forecast state of the first node based on the application of the corrective action.

19. The method of claim 11, wherein the forecast is generated based on historical information of the first node concerning:
loads drawn from the first node;
power received from an intermittent power source connected to the first node; or
power received from a main power source connected to the first node.

20. The method of claim 11, wherein the instructions are received, using power line communications, through a power connection of the first node.
